(19) United States
(12) Patent Application Publication
(10) Pub. No.: US 2012/0169805 A1
(43) Pub. Date: Jul. 5, 2012

(54) SENSOR

(76) Inventors: John E. Bateson, Colleyville, TX (US); Cris R. Miller, Champlin, MN (US); Yanhua Li, Andover, MN (US)

(21) Appl. No.: 13/344,106

(22) Filed: Jan. 5, 2012

Related U.S. Application Data
(60) Provisional application No. 61/429,989, filed on Jan. 5, 2011.

(51) Int. Cl. G01P 3/36; B41J 29/393

(52) U.S. Cl. 347/19; 356/28

(57) ABSTRACT

A sensor device including a base, first and second proximity sensors mounted to the base at a pre-determined distance from one another, and circuitry programmed to determine presence and speed of an article passing by the sensor device based upon signaled information from the proximity sensors.

### CROSS-REFERENCE TO RELATED APPLICATION

This application claims priority under 35 U.S.C. §119(e)(1) to U.S. Provisional Patent Application Ser. No. 61/429989, filed Jan. 5, 2011, entitled “Non-Contact Sensor”, the entire teachings of which are incorporated herein by reference.

### BACKGROUND

The present disclosure relates to non-contact movement sensors. More particularly, it relates to non-contact sensors capable of estimating proximity, direction and velocity of travel of an object and useful, for example, with industrial ink jet printing systems.

Sensors are used in a plethora of environments to detect or sense various movement-related parameters, such as proximity, direction, velocity, etc., of one object relative to another. Movement detecting sensors have a multitude of end-use application, and are commonly utilized to affect control over the operation of machinery or equipment. Industrial ink jet printing systems are but one example of devices that greatly benefit from the implementation of movement detecting sensors. As a point of reference, industrial ink jet printing systems are widely employed across many industries to generate printed indicia on products and packaging. For example, ink jet printing systems are commonly used to print text, bar codes, and graphics on consumer products, building materials, and packaging, all on a mass production basis. The printing systems are often in-line with the manufacturing and/or packaging process, and print real time information directly on the articles of interest. The types of information typically printed include production date, expiration date, lot and shift codes, bar codes, company graphics, product name and description, etc.

With many in-line industrial printing system applications, multiple, spaced apart articles are passed by the printing system's print head on an essentially continuous basis to receive printed indicia. Oftentimes, the user desires to print the indicia on each article at a relatively consistent location and/or near or at an edge of each article. To provide a more fully automated printing process, then, movement detecting sensor(s) are provided with the industrial printing system to detect the presence or proximity of an article relative to the print head, causing the printing system to begin printing on to the article. Further, speed of travel or velocity of each article relative to the print head is sometimes detected, with the printing system dispensing ink droplets as a function of the article's velocity to ensure a desired resolution of the printed indicia. Conventionally, a single photo-sensor (and corresponding circuitry) is utilized to detect the presence or proximity of article relative to the print head. While viable, the single photo-sensor circuit cannot provide any information regarding the article's velocity. A rotary encoder sensor can additionally be provided, and is capable of measuring the article's speed. However, rotary encoders require direct contact with each article, and in many circumstances, direct contact with the article in question is less than desirable. Further, because the corresponding printing system must include both the rotary encoder and the single photo-sensor circuit, overall costs are increased. Finally, neither sensor format can generate information indicative of the article's direction of travel relative to the print head. Typically, direction of travel is determined by an operator or user of the printing system. In many instances, direction of travel could provide important, additional data for automated control of the printing system's operation.

In light of the above, a need exist for a non-contact sensor that can determine presence, velocity and direction of travel of an article and useful, for example, with industrial ink jet printing systems.

### BRIEF DESCRIPTION OF THE DRAWINGS

FIG. 1 is a perspective, exploded view of a non-contact sensor device in accordance with principles of the present disclosure;

FIG. 2 is a perspective view of an industrial printer incorporating the sensor device of FIG. 1;

FIGS. 3A-3C illustrate use of the sensor device of FIG. 1 in determining presence, velocity, and direction of travel of an article.

### DETAILED DESCRIPTION

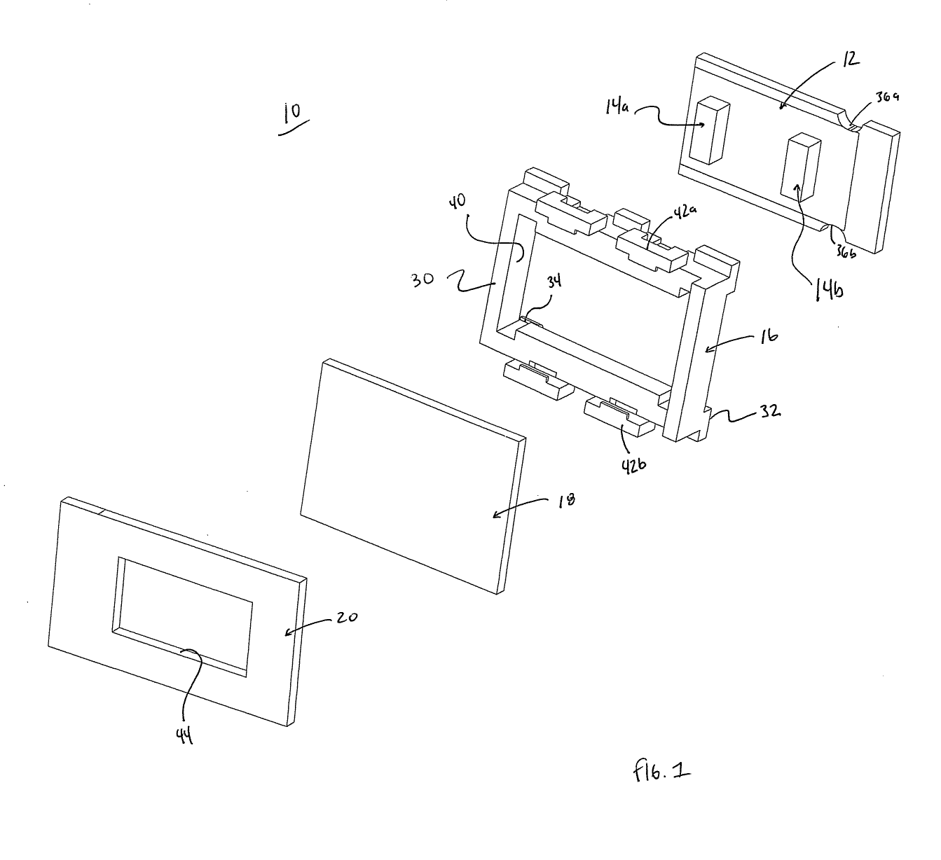

One embodiment of a non-contact sensor device 10 in accordance with principles of the present disclosure and useful with industrial ink jet printing systems is shown in FIG. 1. The sensor 10 includes a base 12, first and second proximity sensors 14a, 14b, a housing 16, a filter 18, and an optional cover 20. Details on the components 12-20 are provided below. In general terms, however, the proximity sensors 14a, 14b are maintained by the base 12 at a predetermined distance, and are electrically connected to circuitry (not shown) that controls operation of, and processes information generated by, the sensors 14a, 14b. The housing 16 retains the base 12 relative to the filter 18, with the filter 18 promoting consistent operation of the sensors 14a, 14b. Where provided, the cover 20 can further enhance operation of the sensor device 10. During use, the sensors 14a, 14b operate to detect the presence of an object in close proximity thereto. The sensor device circuitry combines information generated by the sensors 14a, 14b to not only identify that the article is present, but also the velocity and direction of travel of the article. The filter 18 blocks stray light from interfacing with the sensors 14a, 14b.

The base 12 can assume various forms, and is generally sized and shaped to maintain the sensors 14a, 14b at a desired spacing (e.g., on the order of 5-25 mm). In one embodiment, the sensors 14a, 14b are spaced approximately 12-13 mm from one another. The sensors 14a, 14b are maintained at a spacing which allows the sensors 14a, 14b not to interfere with one another (i.e. cross-talk). Further, the sensors 14a, 14b may be alternately pulsed to eliminate cross-talk. For example, sensor 14a is pulsed on and then turned off, followed by sensor 14b being pulsed on and then turned off. This pattern of alternately pulsing sensors 14a, 14b is repeated as desired. In some embodiments, the base 12 is a printed circuit board (PCB) substrate, with the electronic components necessary for operating the sensors 14a, 14b and interpreting information from the sensors 14a, 14b being embedded into, or mounted on, the base substrate 12 (e.g., circuitry traces, microprocessor, memory, etc.).

The proximity sensors 14a, 14b are, in some embodiments, reflective-type infrared proximity sensors that employ an infrared LED (emitter) and a photodiode detector (receiver). As is known to those of ordinary skill, the infrared LED and the photodiode are next to each other, but are separated by a barrier. The LED emits infrared light pulses. When no object is located in close proximity to the emitted light, the light does not reflect back to the photodiode; thus, the photodiode does not receive or sense the presence of the infrared light. An object is “detected” when the pulsed light is reflected off of the object and back to the photodiode. The reflective-type infrared proximity sensors, and corresponding operational circuitry, are well known. For example, the proximity sensors 14a, 14b can be an analog output reflective proximity sensor available from Avago Technologies of San Jose, CA under the trade designation HSDL-9100.

The housing 16 is sized and shaped for assembly to the base 12, as well as to receive the proximity sensors 14a, 14b. For example, in one embodiment, the housing 16 defines a front 30 and a back 32 (referenced generally), and forms a slot 34 (referenced generally) at the back 32 sized to slidably receive a perimeter of the base 12. Optionally, the housing 16 includes mounting tabs (hidden in the view of FIG. 1) sized to receive opposing notches 36a, 36b formed in the base 12 to facilitate assembly and capture of the base 12 relative to the housing 16. The base 12 may additionally be glued or otherwise affixed to the housing 16. Other mounting configurations are equally acceptable. Regardless, the housing 16 defines a window 40 sized and shaped in accordance with a size, shape, and spacing of the proximity sensors 14a, 14b. The window 40 is open at the front 30; as made clear below, upon final assembly, the proximity sensors 14a, 14b are open to the front 30 exterior of the housing via the window 40 and thus can emit and receive light therethrough. However, the proximity sensors 14a, 14b are “behind” the front 30 such that stray exterior light at the sides of the housing 16 will not enter the window 40 or interfere with operation of the proximity sensors 14a, 14b.

In some embodiments, the housing 16 includes or forms features that facilitate assembly of the filter 18 to the front 30 (and thus optically “over” the proximity sensors 14a, 14b). For example, the housing 16 can include one or more opposing latch bodies 42a, 42b configured to frictionally maintain the filter 18. A wide variety of other mounting techniques are also envisioned (e.g., adhesives, etc.).

The filter 18 is sized and shaped to encompass an entirety of the window 40 at the front 30 of the housing 16, and thus serves to prevent dust and other contaminants from entering the window 40 and interfering with operation of the proximity sensors 14a, 14b. Further, the filter 18 is formed of a material selected to filter or block light at wavelengths consistent with functioning of the proximity sensors 14a, 14b. For example, where the proximity sensors 14a, 14b utilize infrared light, the filter 18 is constructed of a material that blocks light at wavelengths above the infrared spectrum (e.g., visible light). Thus, the filter 18 permits passage of infrared light but prevents stray light from interacting with the proximity sensor's photodetector, such as light emitted from florescent lamps commonly used in many manufacturing environments, ultraviolet light, etc. Many materials are available that provide these properties and in some constructions, the filter 18 is a tinted infrared (IR) optical glass available from Pittsburgh Plate Glass Industries of Pittsburgh, PA.

The optional cover 20 can protect the filter 18 from damage, and can incorporate light absorbing properties that further ensure unwanted stray light does not interact with the proximity sensors 14a, 14b. For example, in some embodiments, the cover 20 is a black foam material disposed over the filter 18. Further, the cover 20 can form an aperture 44 slightly smaller in length and width than the corresponding dimensions of the window 40. In one embodiment, the aperture 44 is sized to fully expose the proximity sensors 14a, 14b, but effectively blocks light at locations slightly away from the proximity sensors 14a, 14b upon final assembly. In other embodiments, the cover 20 can be omitted.

During use, the proximity sensors 14a, 14b are pulsed in order to reduce the effect of any stray light sources such as room lights or sunlight. The signals from the proximity sensors 14a, 14b are combined in another circuit to produce outputs from which article presence, velocity (e.g., quadrature encoder signals), and direction of travel can be determined. In some embodiments, the sensor device 10 further includes a supplemental electrical channel that transmits the speed and direction information in text format, or other formats useful by auxiliary equipment.

In general terms, the presence of an article or object is detected by the sensor device 10 by the article moving into the detection range of one of the proximity sensors 14a, 14b. The velocity or speed of travel of the article is determined by the time interval between when the proximity sensors 14a, 14b are sequentially blocked. The direction of travel of the article is determined by the sequence of the proximity sensor 14a, 14b detections. The sensor device 10 can have outputs that appear to the host unit as two separate sensors.

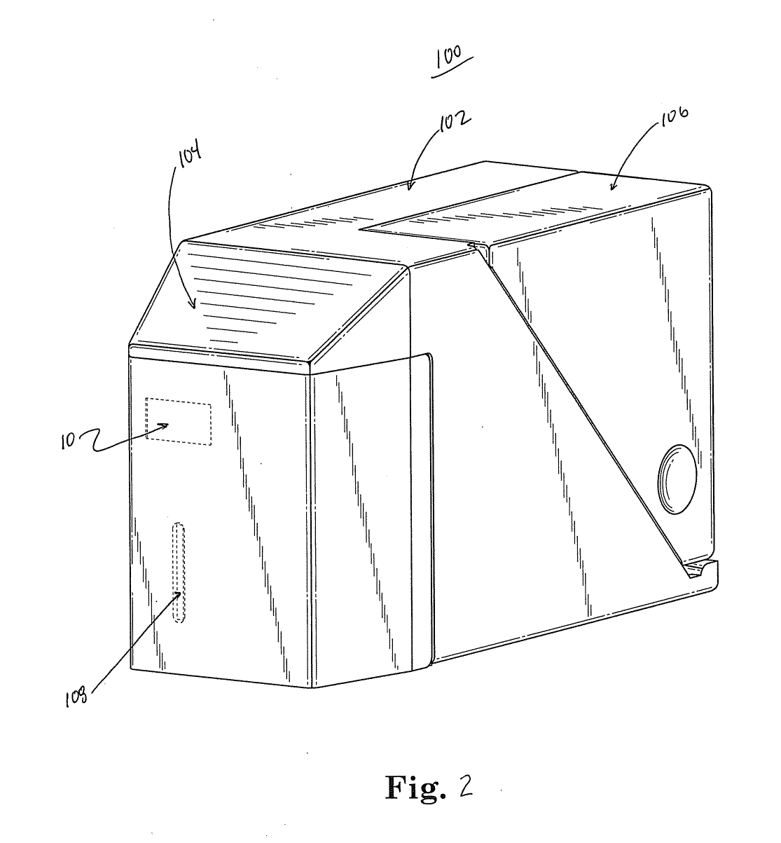

The sensor device 10 can be employed with many discrete end-use applications. However, the sensor device 10 is particularly useful with industrial ink jet printing systems, such as the system 100 shown in FIG. 2. The printing system 100 can assume a wide variety of forms, and generally includes a housing 102 maintaining a print engine 104 (referenced generally), a supply of ink 106, and the sensor device 10. The print engine 104 includes a print head 108. The sensor device 10 is fixedly arranged at a predetermined location relative to the print head 108, and in some embodiments is centered relative to the print head 108.

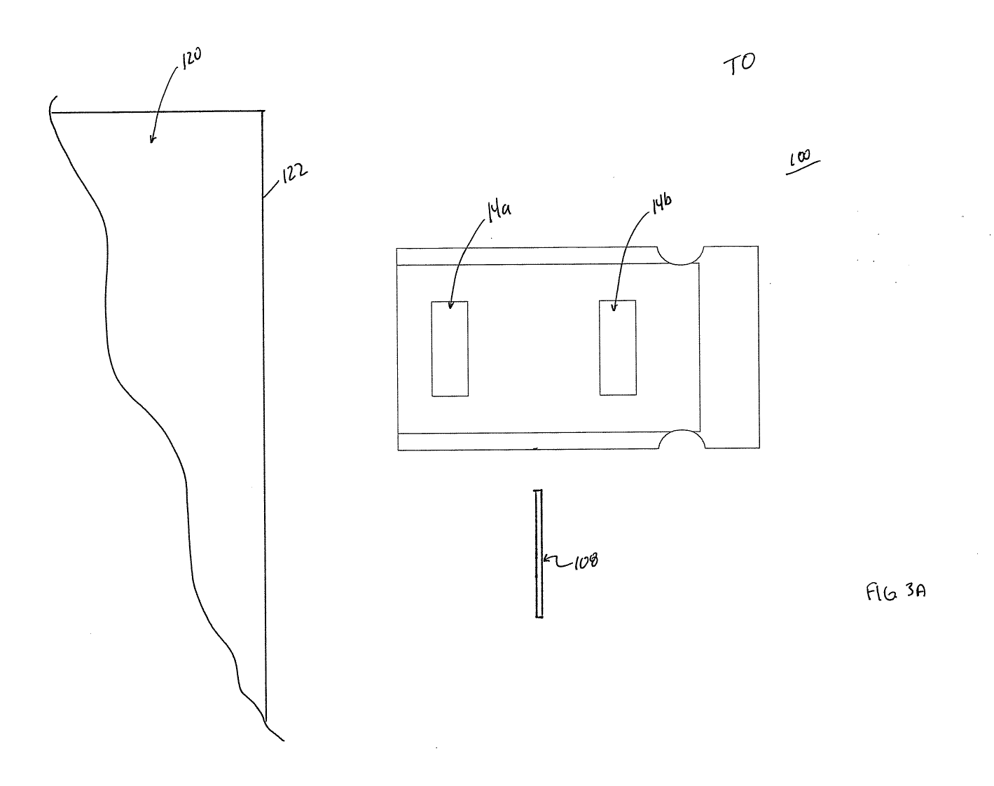

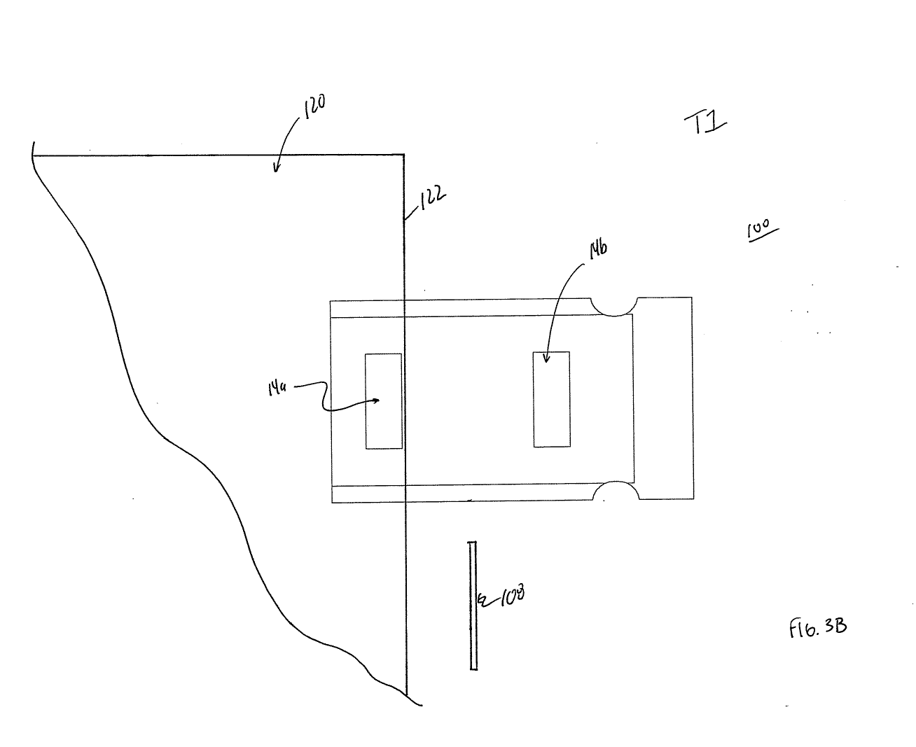

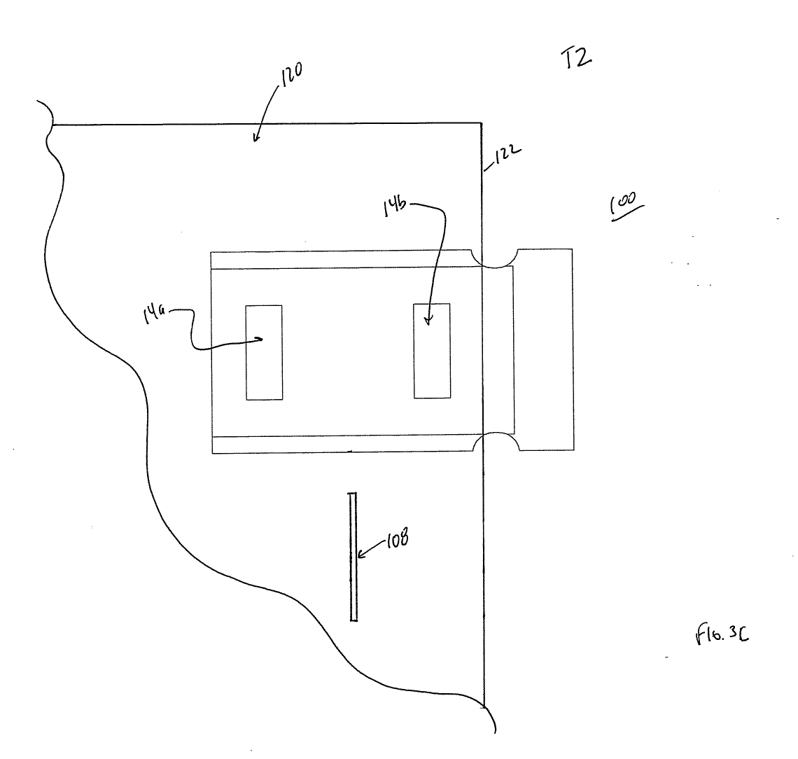

With the above construction in mind, FIG. 3A schematically illustrates the proximity sensors 14a, 14b relative to the print head 108, along with an article 120 on to which printing is desired. In the state of FIG. 3A (time T0), the article 120 is outside of the detection range of the proximity sensors 14a, 14b. Circuitry associated with the printing system 100 interprets this “absence of detection” information from the proximity sensors 14a, 14b, and is programmed to operate in a standby mode so that no printing occurs. In FIG. 3B, at time T1, a leading edge 122 of the article 120 is in front of the first proximity sensor 14a. The first proximity sensor 14a thus signals information indicative of the presence of the article 120, whereas the second proximity sensor 14b continues to indicate that that no object is present (e.g., the second proximity sensor 14b does not have a signaled output). The printing system 100 can be programmed to initiate a printing operation under circumstances where printed indicia at the leading edge 122 is desired, or can wait for further information. FIG. 3C reflects a later time, T2, at which the article 120 has continued moving in the same direction of travel to a spatial location where the leading edge 12 can now be detected by the second proximity sensor 14b. Based upon the known distance between the proximity sensors 14a, 14b and the determined time lapse between T2 and T1, the velocity of the article 120 relative to the print head 108 can be determined. Further, the direction of travel of the article 120 relative to the print head 108 can be determined based upon a recognition that the first proximity sensor 14a signaled an article detection event before the second proximity sensor 14b. Operation of the print engine 104 in dispensing ink from the print head 108 and on to the article 120 can then be controlled in a desired fashion based upon the determined presence, speed, and direction of travel. As a point of reference, the sensor device 10 (and corresponding circuitry and programming) of the present disclosure is capable of determining article velocity at speeds of at least 200 feet/minute with an accuracy of +or −5%.

The sensor devices of the present disclosure provide a marked improvement over previous designs. Two proximity sensors are packaged on a single circuit board a small distance apart. Combining the signals from the two commonly mounted proximity sensors provides information indicative of article presence, speed and direction of travel. The sensor devices of the present disclosure can replace the conventional approach of a single photo-sensor circuit and rotary encoder with a single device generating compatible signals, and do not contact the article being sensed when detecting velocity. In some embodiments, the sensor devices of the present disclosure can include one or more supplemental channels for information transfer of speed and direction of travel in human readable form.

Although the present disclosure has been described with reference to preferred embodiments, workers skilled in the art will recognize that changes can be made in form and detail without departing from the spirit and scope of the present disclosure.

What is claimed is:

1. A sensor device comprising:
a base;
first and second proximity sensors mounted to the base at a predetermined distance from one another; and
circuitry programmed to determine presence and speed of an article passing by the sensor device based upon signaled information from the proximity sensors.

2. The sensor device of claim 1, wherein the proximity sensors are reflective-type infrared proximity sensors.

3. The sensor device of claim 1, wherein the circuitry is further programmed to determine a direction of travel of the article based upon signaled information from the proximity sensors.

4. The sensor device of claim 1, wherein the circuitry is formed on the base.

5. The sensor device of claim 1, wherein the base is a printed circuit board substrate.

6. The sensor device of claim 1, further comprising a housing mounted to the base and surrounding the proximity sensors, the housing forming a front side window at which the proximity sensors are exteriorly exposed.

7. The sensor device of claim 6, further comprising a filter assembled to the housing at the front side window.

8. The sensor device of claim 7, wherein the filter is comprised of an infrared tinted optical glass.

9. The sensor device of claim 7, further comprising a cover disposed over the filter, the cover forming an aperture corresponding to the front side window.

10. A sensor device comprising:
a printed circuit board; and
a first sensor and a second sensor mounted to the printed circuit board at a predetermined distance between the first sensor and the second sensor;
wherein the printed circuit board includes circuitry configured to process information from the first sensor and the second sensor to determine presence and speed of an article relative to the sensor device without physical contact between the sensor device and the article.

11. The sensor device of claim 10, wherein the predetermined distance is in the range of 5 mm to 25 mm.

12. The sensor device of claim 10, further comprising a housing including a front side including a window and a backside, wherein the printed circuit board is disposed along the backside, and wherein the first sensor and second sensor are disposed within an interior perimeter of the housing between the front side and backside the front side.

13. The sensor device of claim 12, further comprising a filter disposed along the front side of the housing.

14. The sensor device of claim 13, wherein the filter is configured to encompass an entirety of the window opening.

15. The sensor device of claim 13, wherein the first sensor and second sensor are infrared proximity sensors and the filter blocks light at wavelengths above the infrared spectrum.

16. The sensor device of claim 10, wherein the circuitry is further programmed to determine a direction of travel of the article based upon signaled information from the sensors.

17. A printing system comprising:
a housing;
a print engine maintained by the housing and including a print head; and
a sensor device maintained by the housing at a fixed location relative to the print head, the sensor device comprising:
a base;
first and second proximity sensors mounted to the base at a pre-determined distance from one another; and
circuitry programmed to determine presence and speed of an article passing by the sensor device based upon signaled information from the proximity sensors.

18. The printing system of claim 17, wherein the print engine operates to dispense ink from the print head based on the determined presence and speed of the article passing by the sensor device.

19. The printing system of claim 17, wherein the circuitry is programmed to further determine a direction of travel of the article passing the sensor device based on signaled information from the proximity sensors.

20. The printing system of claim 19, wherein the print engine operates to dispense ink from the print head based on the determined presence, speed, and direction of travel of the article passing by the sensor device.
